(19) United States
(12) Patent Application Publication
(10) Pub. No.: US 2025/0370999 A1
(43) Pub. Date: Dec. 4, 2025

(54) CONFIGURING INTERACTIONS BETWEEN PYTHON AND SQL CELLS IN A NOTEBOOK

(71) Applicant: Snowflake Inc., Bozeman, MT (US)

(72) Inventors: Xiaoxiao He, Foster City, CA (US); Jung Lin Lee, El Dorado Hills, CA (US); Jue Liu, San Mateo, CA (US); Nan Lu, Oakland, CA (US); William A. Pugh, Seattle, WA (US); Tyler Jeffrey Simons, Palo Alto, CA (US)

(21) Appl. No.: 18/680,841

(22) Filed: May 31, 2024

(51) Int. Cl. G06F 16/242; G06F 16/2455

(52) U.S. Cl. CPC G06F 16/2433; G06F 16/2455

(57) ABSTRACT

Provided herein are systems and methods for configuring interactions between Python and SQL cells in a notebook. An example method includes detecting a run cell message received from a notebook UI application. The run cell message specifies a set of cells of a notebook. At least a first cell of the set of cells is configured as an SQL cell within the notebook. A query within at least one SQL statement associated with the SQL cell is executed to generate cell results. The cell results of the SQL cell are stored in a global namespace of the notebook. Access to the cell results in the global namespace is configured to at least a second cell of the set of cells.

### TECHNICAL FIELD

Embodiments of the disclosure relate generally to notebooks in data platforms and, more specifically, to techniques for configuring interactions between Python and Structured Query Language (SQL) cells in a notebook.

### BACKGROUND

Databases are widely used for data storage and access in computing applications. A goal of database storage is to provide enormous sums of information in an organized manner so that it can be accessed, managed, updated, and shared. Data may be organized into rows, columns, and tables in a database. Different database storage systems may be used to store different types of content, such as bibliographic, full text, numeric, and image content. Further, in computing, different database systems may be classified according to the organizational approach of the database. There are many different types of databases, including relational, distributed, cloud, object-oriented, and others.

Databases may include one or more tables that include or reference data that can be joined, read, modified, or deleted using queries. Databases can store small or large sets of data within one or more tables. This data can be accessed by various users in an organization or even be used to service public users, such as via a website or an application program interface (API). Both computing and storage resources and their underlying architecture can play a significant role in achieving desirable database performance, including facilitating access to different types of data.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager, including a notebook service manager (NSM), in accordance with some embodiments of the present disclosure.

FIG. 3 is a block diagram illustrating components of an execution platform with a notebook adapter, in accordance with some embodiments of the present disclosure.

FIG. 4 is a collaboration diagram of a predictable notebook system, in accordance with some embodiments of the present disclosure.

FIG. 5 is a data structure of a run cells message, in accordance with some embodiments of the present disclosure.

FIG. 6 is a data structure and data flow diagram of a notebook user interface, in accordance with some embodiments of the present disclosure.

FIG. 7 is a data structure diagram of a message path, in accordance with some embodiments of the present disclosure.

FIG. 8 is a collaboration diagram of a predictable notebook system and a notebook UI application, in accordance with some embodiments of the present disclosure.

FIG. 9 is a block diagram illustrating a configuration of a cell with a multi-SQL statement, in accordance with some embodiments of the present disclosure.

FIG. 10 illustrates chaining queries in multiple cells of a notebook, in accordance with some embodiments of the present disclosure.

FIG. 11 illustrates a configuration of distributed machine learning (ML) operations in multiple cells of a notebook, in accordance with some embodiments of the present disclosure.

FIG. 12 illustrates a configuration of writing Arrow files locally in connection with multiple cells of a notebook, in accordance with some embodiments of the present disclosure.

FIG. 13 illustrates a configuration of multi-statement SQL cells of a notebook, in accordance with some embodiments of the present disclosure.

FIG. 14 is a flow diagram illustrating the operations of a database system in performing a method for configuring interaction between different types of cells in a notebook, in accordance with some embodiments of the present disclosure.

FIG. 15 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and the like. If stored internally in the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Notebook interactive computing environments are popular with users of complex data systems as a notebook allows users to create, share, and execute code, visualizations, and explanatory text in a single document. As used herein, the term “notebook” indicates a set of cells that can contain different types of content, including code snippets, text explanations, mathematical formulas, visualizations, and more. Each cell can be individually executed, enabling users to iteratively develop and test their code or analyze data step by step.

Notebooks provide a unified interface where users can combine code, documentation, and visualizations, making it easier to communicate findings and insights. They are prevalent in data science, machine learning, and data engineering workflows, as they facilitate the interactive exploration and experimentation with data. Within a data platform, notebooks often integrate with various data processing frameworks and libraries, such as Python's PANDAS, NUMPY, and SCIKIT-LEARN, or R's TIDYVERSE packages. This integration allows users to leverage the platform's capabilities, such as distributed computing, data querying, and visualization tools, to perform complex data operations and analyze large datasets efficiently.

Notebook User Interface (UI) applications are widely used for creating and sharing documents that contain code, visualizations, and narrative text. These applications allow users to create interactive documents that can be used for data analysis, scientific research, and education. In these applications, users can create a set of cells that contain code, text, and visualizations. These cells can be executed in a specific order to generate a set of results that can be used to create a narrative or to perform data analysis.

In some aspects, the disclosed techniques can be used for SQL-based interaction between Python and SQL cells in a notebook.

Jupyter notebooks can be configured in Python. In some aspects, such Python-based notebooks can use “magic” cells (or magics) that allow SQL to be executed. However, it can be challenging to integrate the SQL and Python cells. More specifically, cell magics in Jupyter have limitations that make them hard to use for larger SQL or iterating on SQL. Additionally, the magics do not allow re-using SQL in other SQL magics or efficiently re-using the results of large, complicated queries in Python. Line magics make it easy to re-use the results of SQL but make it harder to manage the SQL a user would like to use.

The disclosed techniques take advantage of several aspects that are associated with using notebooks in a database system where the notebook has SQL as a first class concept. The disclosed techniques can be used to configure a separate notebook cell type, which is an SQL cell. The results of such an SQL cell can be shared between Python and SQL cells. In this regard, SQL queries can be directly applied to results generated by the SQL cell.

In some aspects, data frames can be used to combine SQL statements iteratively. In some aspects, result scanning (or any other functions or mechanisms for using or re-using results) can be used to reuse results from previous queries. In some aspects, a kernel can be configured to allow the use of different syntaxes and UIs across cells. More specifically, separately defined SQL and Python cells can be configured with their own distinct rules while sharing the same variable namespace (also referred to as a global namespace).

In some aspects, the disclosed NSM can configure a Python object that represents the results of an SQL cell with the following characteristics:
(a) The object encompasses a data frame;
(b) The object can be translated to SQL by SQL cells;
(c) The object can be turned into rows (e.g., PANDAS, rows, Arrow, etc.) for process results directly in Python; and
(d) The object can be used as a data frame for further SQL work in Python.

In some aspects, when an SQL cell is executed, the cell can be added to a global collection of cell results. It can be injected into the local Python variable space (e.g., the global namespace). Since the SQL cells share the same variable space as the Python, the SQL cell results can be reused in either place.

The disclosed techniques for facilitating interaction between Python and SQL cells are associated with the following advantages over conventional techniques that do not configure such cell interaction and re-use of SQL cell results:
(a) The disclosed techniques can be used to configure the composition of SQL operations. Instead of having to write complicated common table expression (CTE) statements, users can iteratively build more complicated SQL statements one cell at a time.
(b) The disclosed techniques can be used to configure the re-use of complicated SQL statements through cell results that are injected as Python parameters.
(c) The disclosed techniques can be used to configure re-using Python in SQL cells via Jinja templating to allow seamless back-and-forth interaction. In some aspects, other templating or pre-processing of the SQL cells can be performed as well.
(d) The disclosed techniques can be used to configure the operation RESULT_SCAN to allow later SQL cells to be run more efficiently than the traditional CTE approach because it can build on previously aggregated/filtered data.
(e) The disclosed techniques can be used to configure the use of data frames to take a SQL cell and then build additional SQL on top of it in Python.

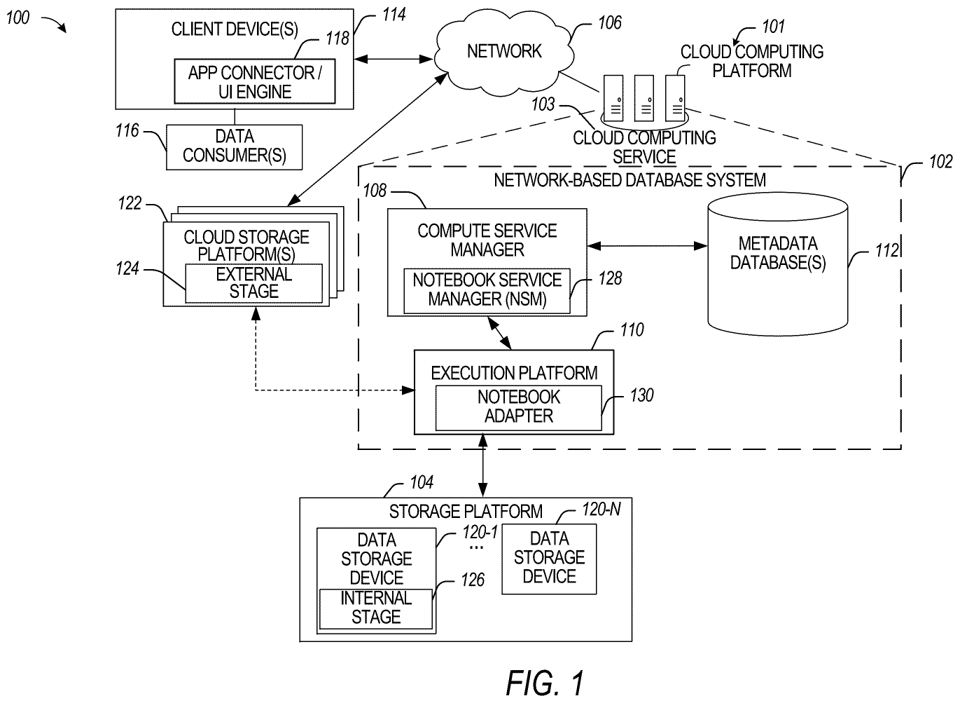

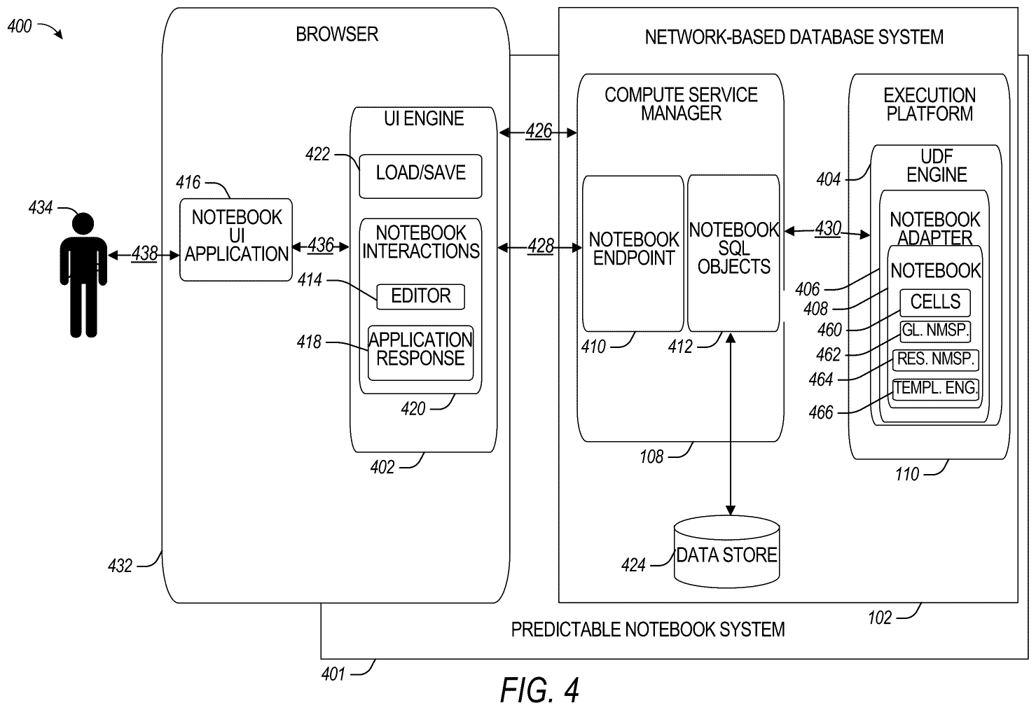

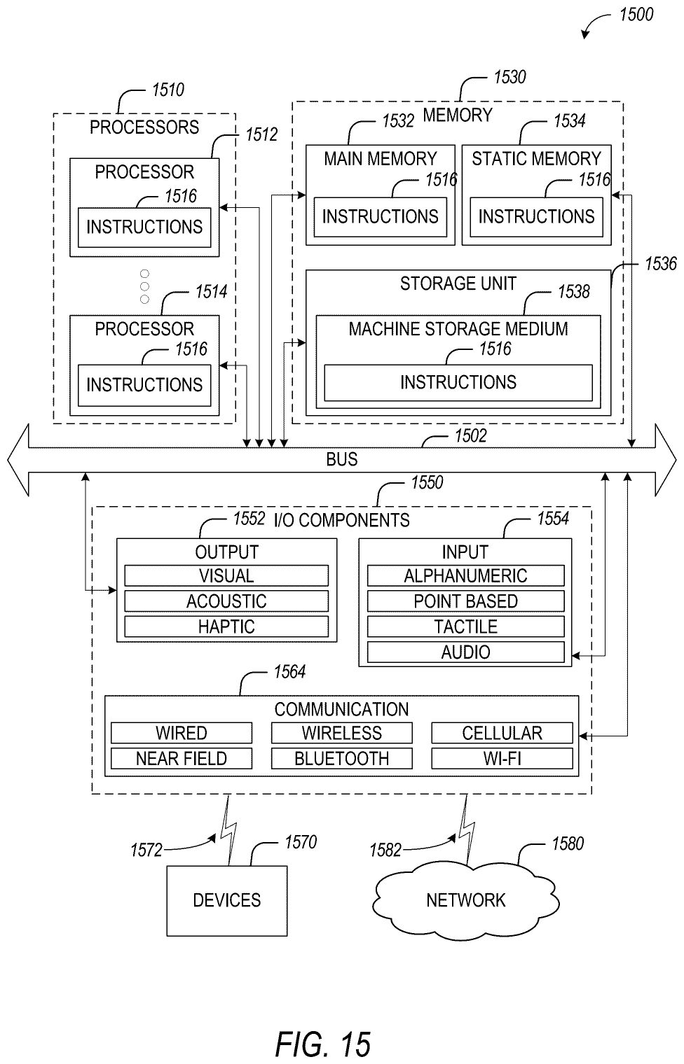

The various embodiments that are described herein are described with reference, where appropriate, to one or more of the various figures. An example computing environment using an NSM is discussed in connection with FIGS. 1-3. Example functionalities of the NSM in connection with configuring a notebook and facilitating interaction between different cell types (e.g., between a Python cell and an SQL cell) in a notebook are further discussed in connection with FIGS. 4-14. A more detailed discussion of example computing devices that may be used in connection with the disclosed techniques is provided in connection with FIG. 15.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not explicitly described herein. In other embodiments, the computing environment may comprise another type of network-based database system or a cloud data platform. For example, in some aspects, the computing environment 100 may include a cloud computing platform 101 with the network-based database system 102, storage platforms 104, and cloud storage platforms 122. The cloud computing platform 101 provides computing resources and storage resources that may be acquired (purchased) or leased (e.g., by data providers and data consumers) and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the hash-join broadcast decision-making functions described herein). The cloud computing platform 101 may include a three-tier architecture: data storage (e.g., storage platforms 104 and 122), an execution platform 110, and a compute service manager 108 providing cloud services. In some embodiments, the execution platform 110 is configured to provide services (e.g., a notebook adapter 130) associated with notebook-based configurations using NSM 128 (e.g., in connection with configuring a notebook with different types of cells and facilitating communication between the cells, including sharing of cell results).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and files of one or more other types—on, as examples, one or more of their servers and on one or more cloud-storage platforms such as AMAZON WEB SERVICES™ (AWS™), MICROSOFT® AZURE®, GOOGLE CLOUD PLATFORM™, and the like. The customer's servers and cloud-storage platforms are both examples of what a given customer could use as what is referred to herein as an external storage location. The cloud computing platform 101 could also use a cloud-storage platform, which is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations. Internal files can be stored in internal stages at one or more internal storage locations, which can include servers managed and controlled by the same organization (e.g., company) that manages and controls the data platform and which can instead or in addition include data storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage), client device 114 (e.g., a data provider), and data consumer 116 via network 106. The network-based database system 102 is a network-based system used for reporting and analysis of integrated data from one or more disparate sources, including one or more storage locations within the cloud storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed hash-join broadcast decision-making functions) to multiple client accounts, including an account of the data provider associated with client device 114 and an account of the data consumer 116. In some embodiments, the execution platform 110 comprises the NSM 128, which can be used in connection with notebook-based functions. Example notebook-based functions include configuring a notebook (e.g., using the notebook adapter 130) with different types of cells (e.g., a Python cell and an SQL cell) and facilitating communication between the cells, including sharing cell results. A more detailed description of the notebook-based functions provided by the NSM 128 is provided in connection with, e.g., FIGS. 4-14.

The compute service manager 108 coordinates and manages operations of the network-based database system 102. The compute service manager 108 also performs query optimization and compilation and manages clusters of computing services that provide computing resources (also referred to as “virtual warehouses”). The compute service manager 108 can support any number of client accounts, such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 114. The client device 114 corresponds to a user of one of the multiple client accounts (e.g., a data provider) supported by the network-based database system 102. The data provider may utilize application connector 118 at the client device 114 to submit data storage, retrieval, and analysis requests to the compute service manager 108 as well as to access or configure other services provided by the compute service manager 108 (e.g., services associated with the disclosed hash-join broadcast decision-making functions). In some aspects, the client device 114 can include a browser with a notebook UI application and a UI engine (e.g., as illustrated in FIG. 4).

Client device 114 (also referred to as user device 114) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 114 to access functions offered by the data provider. Additionally, the data consumer can access functions (e.g., hash-join broadcast decision-making functions) offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, communication links between elements of the computing environment 100 are implemented via one or more data communication networks, such as network 106. The one or more data communication networks may utilize any communication protocol and any communication medium. In some embodiments, the data communication networks are a combination of two or more data communication networks (or sub-networks) coupled with one another. In alternate embodiments, these communication links are implemented using any communication medium and any communication protocol.

The compute service manager 108, metadata database 112, execution platform 110, and storage platform 104 are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operations, the network-based database system 102 processes multiple jobs as determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from and store data to any of the data storage resources in the cloud storage platform 104.

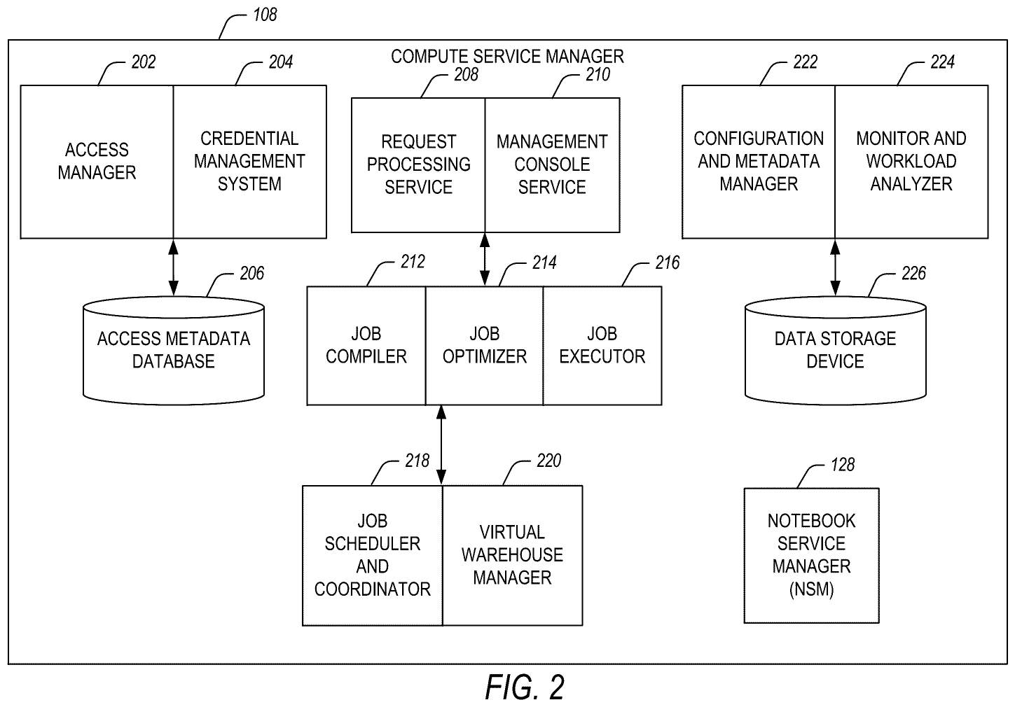

FIG. 2 is a block diagram illustrating the components of the compute service manager 108, including the NSM 128, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources, such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports administrators and other system managers' access to various systems and processes. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes a configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2) and should be disallowed from communicating with a third execution node (e.g., execution node 312-1) and any such illicit communication can be recorded (e.g., in a log or other location). Also, the information stored on a given execution node is restricted to data relevant to the current query, and any other data is unusable, rendered so by destruction or encryption where the key is unavailable.

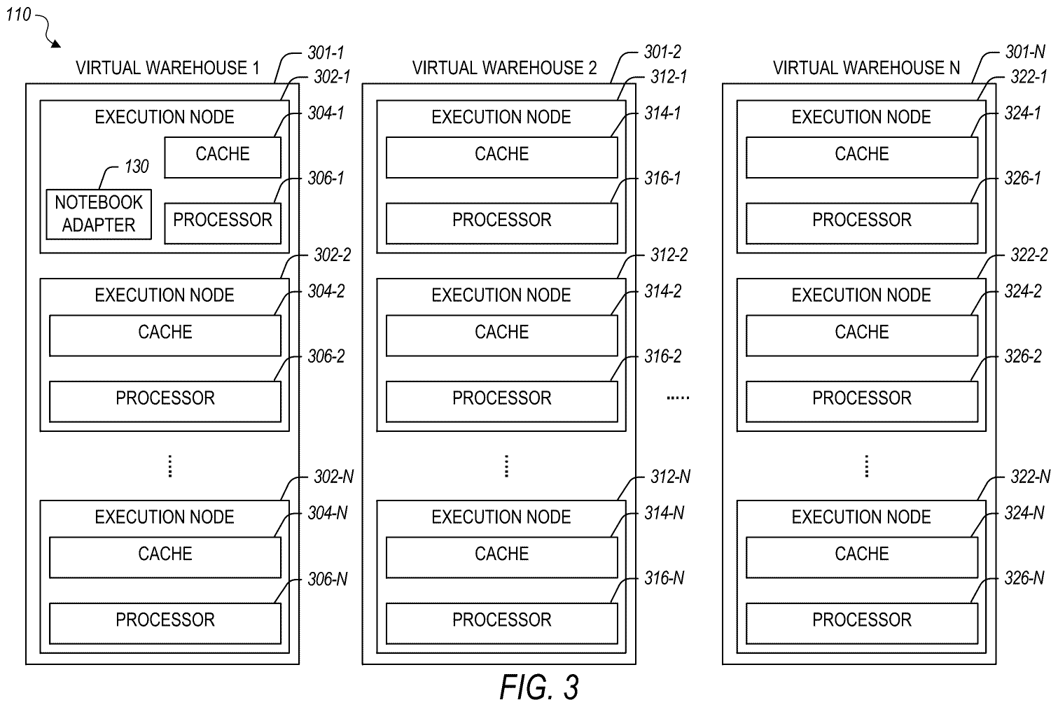

FIG. 3 is a block diagram illustrating components of the execution platform 110 with a JPM, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, they can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device. Still, the virtual warehouse or execution node may later access data from any other data storage device.

In the example of FIG. 3, virtual warehouse 1 includes three execution nodes: 302-1, 302-2, and 302-N. Execution node 302-1 includes notebook adapter 130, a cache 304-1, and a processor 306-1. Notebook adapter 130 can be the same as the notebook adapter described in connection with FIG. 4. Execution node 302-2 includes a cache 304-2 and a processor 306-2. Execution node 302-N includes a cache 304-N and a processor 306-N. Each execution node 302-1, 302-2, and 302-N is associated with processing one or more data storage and data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes: 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes: 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes. This is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, which is helpful for tasks that require fast scanning of large amounts of data. In some embodiments, the cache resources and computing resources associated with a particular execution node are determined when the execution node is created based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , and N may be implemented using multiple computing systems at multiple geographic locations. For example, virtual warehouse 1 can be implemented by a computing system at a first geographic location, while another computing system implements virtual warehouses 2 and n at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and caching resources are needed. Similarly, existing virtual warehouses may be deleted when the resources associated with the virtual warehouse are no longer necessary.

In some embodiments, the virtual warehouses may operate on the same data in the cloud storage platform 104. Still, each virtual warehouse has its execution nodes with independent processing and caching resources. This configuration allows requests on different virtual warehouses to be processed independently and with no interference between the requests. This independent processing, combined with the ability to add and remove virtual warehouses dynamically, supports the addition of new processing capacity for new users without impacting the performance observed by the existing users.

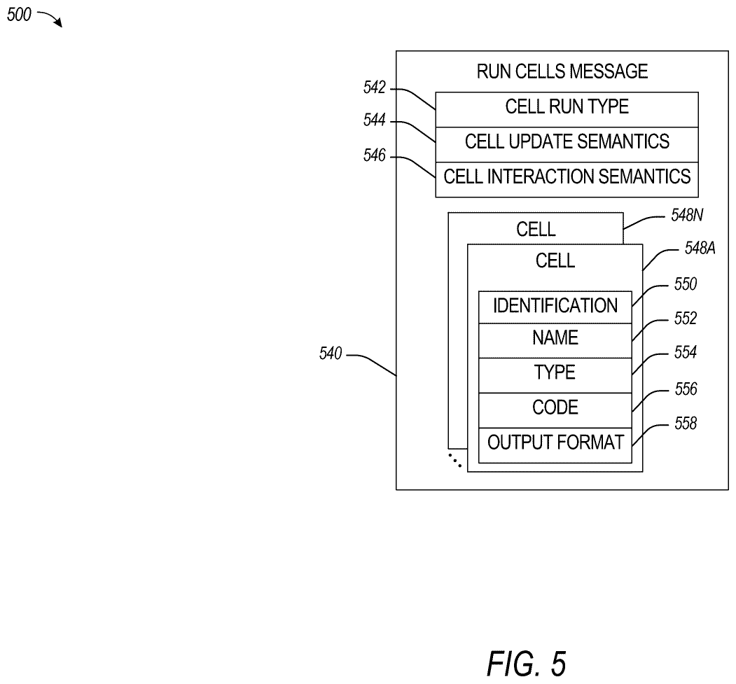

FIG. 4 is a collaboration diagram 400 of a predictable notebook system 401, and FIG. 5 is a data structure of a run cells message, in accordance with some embodiments of the present disclosure.

A data platform (e.g., network-based database system 102) uses a predictable notebook system 401 to provide notebook services to a user 434 of the data platform.

The predictable notebook system 401 comprises a User Interface (UI) engine 402 that communicates with a User Defined Function (UDF) engine 404 executing on the execution platform 110 of the network-based database system 102. The UI engine 402 and the UDF engine 404 communicate with each other via the compute service manager 108, which performs Create Read Update and Delete (CRUD) operations for the predictable notebook system 401. The user 434 uses a notebook UI application 416 that is a component of a browser 432 to interact with the predictable notebook system 401 using a set of user interactions 438. The UI engine 402 provides facilities to load and save 422 a notebook and facilities for notebook interactions 420 such as an editor 414 and viewing an application response 418. In some examples, the UI engine 402 is a component of the network-based database system 102. In some examples, the UI engine 402 is a component of the browser 432.

In some examples, notebook 408 comprises one or more cells 460, a global namespace 462, a result namespace 464, and a templating engine 466. The templating engine 466 can be a Jinja templating engine and can also be configured as part of the notebook adapter 406 or the UDF engine 404. The one or more cells 460 comprise respective executable instructions in the form of script or code that is executed within a context of the notebook adapter 406 component of the UDF engine 404 to generate respective result data for each cell that is run.

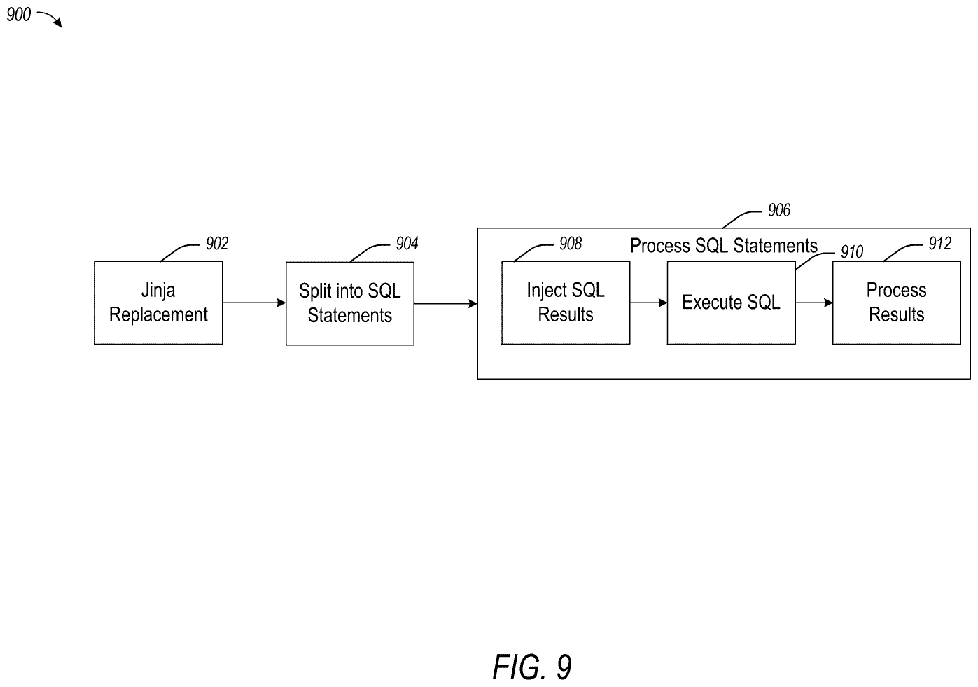

In some aspects, the templating engine 466 is used to configure the one or more cells 460 as an SQL cell in connection with facilitating communication and sharing cell results between Python and SQL cells. An additional description of such functionalities is provided in connection with FIGS. 9-14.

The predictable notebook system 401 supports two or more communication channels. A management channel 426 comprises management commands used to create and manage one or more notebooks, such as notebook 408. The management commands run in the context of the UI engine 402. In some examples, the management commands comprise SQL commands. Example commands supported by the management channel 426 include but are not limited to “Create” to create a notebook, “Delete” to delete a notebook, “Save” to save a notebook, and “SaveResults” to save the results of a notebook.

In some examples, a “SaveResults” command stores the results of a run for re-use. Notebooks are often used as read-only views for business users. As a result, such a command provides an explicit user save operation to update the results users will see. In some examples, such a command alleviates concurrency issues where a user is seeing results from another user using a notebook to explore a data set. In some examples, such a command allows a simpler security model because there is an explicit action for sharing results. In some examples, having an explicit command to save reusable results provides for quicker execution of one or more cells of the notebook.

In some examples, the execution platform 110 uses PUT operations to save results. During operation, the UI engine 402 performs a PUT operation to the notebook's storage location with a <cell_id>.bin file for each cell of a notebook the UI engine 402 caches results for. In some examples, this file is a stream of protocol buffer messages needed to reconstitute the cell. In some examples, the protocol buffer messages are composed in a language-agnostic Interface Definition Language (IDL) to define the structure of the cell data in a schema-like format. The schema defines the types of data fields, their names, and their hierarchical relationships. In some aspects, the protocol buffer messages may be composed in a Protocol Buffers (protobuf) open-source cross-platform data format.

In some examples, a “Save” or “SaveResults” operation runs in the context of the user 434 of the UI engine 402, not the notebook 408. For example, if the user 434 includes a “USE ROLE” command in a notebook cell, it will not affect the ability of the user 434 to save the notebook 408. In some examples, data of the management channel 426 is not affected by a command such as “USE ROLE” while data of the interaction channel 426 is affected by the command.

An interaction channel comprises interaction commands that run notebook cells and update an in-memory state in the predictable notebook system 401. These commands are run in the security context of the notebook 408. This means that running a “USE ROLE” command in a cell affects how the interaction commands are run. The interaction commands are issued by the UI engine 402 front-end during a cycle of interactions by user 434 with the predictable notebook system 401.

In some examples, the interaction channel comprises notebook messages 436 between the notebook UI application 416 and the UI engine 402. The notebook messages 436 are communicated via a UI engine 402 websocket. Some messages to the UI engine 402 to the notebook UI application 416 comprise components of a message path referring to which cells of a notebook the message is to go to. In some examples, the message path has a number of different semantics to run, allowing users to execute their notebooks in different ways.

The interaction channel further comprises a UI engine/notebook interaction channel 428 component for communications between the UI engine 402 and the compute service manager 108. Communications via the UI engine/notebook interaction channel 428 comprise messages that implement a UI engine-to-notebook communication protocol. The compute service manager 108 provides a notebook endpoint 410 for communications between the notebook UI application 416 and the predictable notebook system 401 when communicating over a Wide Area Network (WAN) such as the Internet or the like.

In some examples, when cells of notebook 408 are run, the cells access, read, and write one or more notebook SQL objects 412 that are stored in the data store 424.

The interaction channel further comprises a process interaction channel 430 used for communications between the compute service manager 108 and the UDF engine 404. In some examples, messages communicated through the process interaction channel 430 are composed in a dialect of a remote procedure call protocol such as Google Remote Procedure Call (gRPC) protocol.

FIG. 5 is a data structure 500 of a run cells message, in accordance with some embodiments of the present disclosure. A run cells message 540 is used by the notebook UI application 416 to request a set of operations to be run for a notebook. In some examples, a run cells message 540 comprises a cell run type field 542 that specifies which cells to run.

A cell update semantics field 544 specifies whether a list of cells being passed down should be considered as the entire notebook or as just updates to the notebook. In some examples, inserting, deleting, or re-ordering the cells in a notebook is accomplished by sending a full notebook down with a REPLACE semantic. An INCREMENTAL semantic only allows content updates for existing cells.

A cell interaction semantics field 546 specifies an interaction across cells. In addition to the semantics fields, the run cells message 540 comprises a list of one or more cells, such as cells 548A, . . . , 548N. The list of one or more cells is used to update an internal memory representation of the notebook. In some examples, the actual cells that are run are based on the cell run type field 542.

An identification 550 field contains a unique identifier of a cell. In some examples, the identifier is unique across the notebook. In some examples, the values in the identification 550 field are internal structures that a user does not need to know.

A name 552 field contains an optional name, but when set, it is unique across the notebook. In some examples, when looking up results, the value in the name 552 field is what will be used.

A type 554 field includes a value indicating the type of a cell. For example, a cell type may be a Markdown cell containing commands in a markup language, a SQL cell containing commands in SQL, a Python cell containing Python code, or the like.

A code 556 field contains the actual code that will be run when evaluating a cell.

An output format 558 field contains any additional information needed to render results. If nothing is specified, a set of default semantics is used. The use of the output format 558 field allows a notebook UI application 416 to specify visual UI elements such as, but not limited to, charts, graphs, and the like for displaying results to a user. For example, specifying “VEGALITE” means the results will be rendered using the high-level visualization grammar Vega-Lite, and the configuration for the output format will be used as a Vega-Lite configuration.

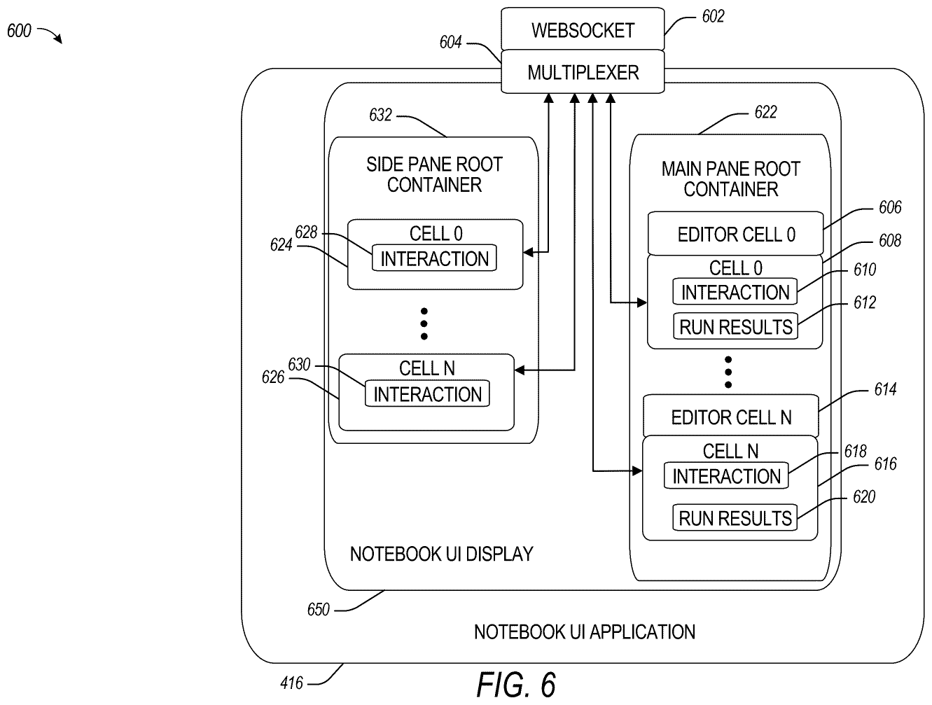

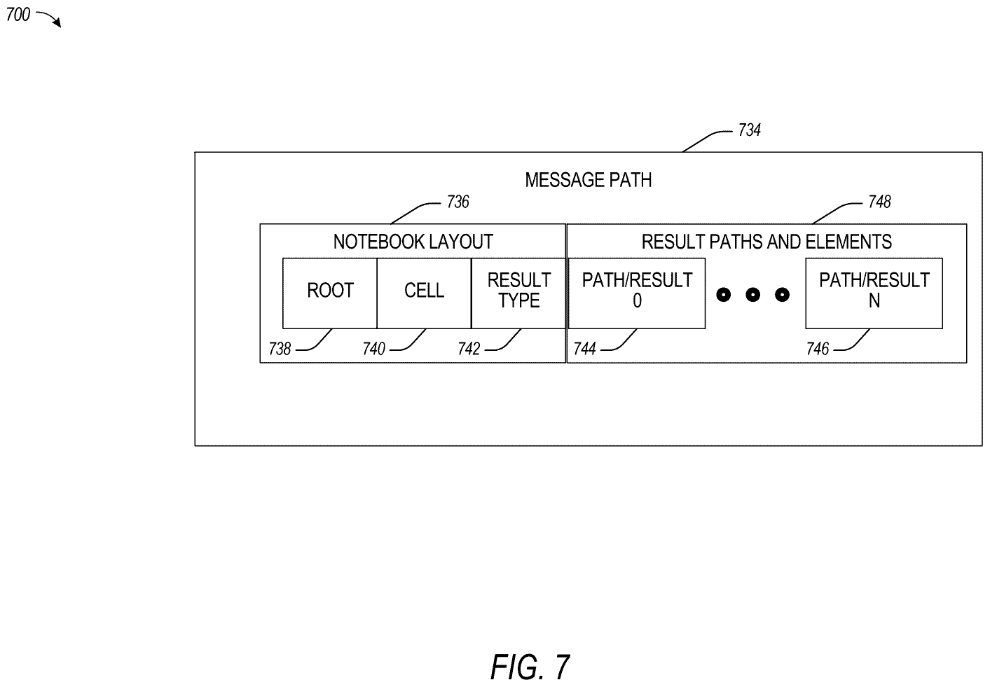

FIG. 6 is a data structure and data flow diagram 600 of a notebook user interface, in accordance with some embodiments of the present disclosure. FIG. 7 is a data structure diagram 700 of a message path, in accordance with some embodiments of the present disclosure. A predictable notebook system 401 uses a message path 734 to route messages to individual cell displays of a notebook UI application 416 (of FIG. 4) via a multiplexer 604.

The notebook UI application 416 comprises one or more root containers of a notebook UI display 650, such as, but not limited to, a side pane root container 632 and a main pane root container 622. The root containers comprise one or more cell containers such as, but not limited to, cell 0 624 and cell N 626 of side pane root container 632, and cell 0 608 and cell N 616 of main pane root container 622. Each cell comprises one or more result containers such as, but not limited to, interaction UI results 610 and run results 612 of cell 0 608, interaction UI results 618 and run results 620 of cell N 616, interaction UI results 628 of cell 0 624, and interaction UI results 630 of cell N 626. Each cell is also associated with a respective editor, such as editor 606 and editor 614.

During operation, the predictable notebook system 401 generates messages with message paths such as, but not limited to, message path 734. Message path 734 is comprised of a notebook layout 736 component and a result paths and elements 748 component. The notebook layout 736 component is comprised of a root 738 field containing a value for identification of a root container such as but not limited to, side pane root container 632 or main pane root container 622, a cell 740 field containing an identification of a cell, and a result type 742 field containing a type of a result contained in the message. Example field values are illustrated in Table 1 below:

TABLE 1

| Path | | | |
|---|---|---|---|
| Index | Container | Description | Values |
| 0 | Root | Topmost choice between | 0 == main |
| | Container | sidebar or main | 1 == sidebar |
| 1 | Cell | The cell this forward message | Index of the cell |
| | Container | to go to | this result was |
| | | | meant for |
| 2 | Result | Containers within the cell | 0 == Interaction UI |
| | Type | | 1 == Result |

The result paths and elements 748 component comprises one or more result path and/or element path containers as indicated by path/result 0 744 and path/result N 746. Each result path container contains a result of a run of a respective cell from which the result will be rendered for display to a user. An element path container includes a path within a result itself to an element of the result.

During operation, the notebook UI application 416 receives and sends messages to a predictable notebook system using a websocket 602 coupled to a multiplexer 604. The multiplexer 604 component of the notebook UI application 416 routes messages from the predictable notebook system using a message path 734 for each message. As an example using Table 1, a message intended for the run results 612 container of cell 0 608 would have a message path where the root 738 field has a value of “0”, a cell 740 field has a value of “0,” a result type 742 field has a value of “1,” and a result path container contains the result of the run of cell 0 608.

In some examples, messages sent from a predictable notebook system to a notebook UI application 416 are formatted as protocol buffers.

In some examples, a subset of a set of cells of a notebook may be run without running the cells that are not included in the subset. To do so, a notebook UI application 416 sends a notebook message to the predictable notebook system in order to have the predictable notebook system run a subset of the cells of the notebook. For example, the notebook UI application 416 sends an “add_block” message for each cell of the subset of cells to be run to the predictable notebook system. All cells that are run will have add_block messages sent for them in the main pane root container 622, as well as for an interaction UI result. An interaction UI block contains any messages sent as a result of running the cell. A result block for a return message is created if there is a non-null or non-delta generator result from running a cell. The result block contains a display for the result itself. The display has an output format specification on the cell applied to it.

In some examples, the notebook UI application 416 is an internet-based user interface and uses Hypertext Markup Language (HTML) elements such as, but not limited to, inline Frames (iFrames) that allow the embedding of another HTML document within the notebook UI display 650. In some examples, the predictable notebook system 401 uses a UDF executed by the UDF engine 404 (of FIG. 4) to generate the content for the HTML elements.

In some examples, not all cells will have messages created for them. If a cell is not run, an add_block message will not be sent. As an example, a notebook UI application 416 may receive a delta path of [1, 2] without getting a delta path of [1, 1], meaning that cell 2 was run and cell 1 was not. Accordingly, the UI should not change anything in the results for cell 1.

In some examples, a file format for a notebook is the IPython Notebook (.ipynb) format. In some examples, results are ignored; that is, during a file read process, the results are not processed. In some examples, notebook metadata is ignored as well. In some examples, cell metadata is used to store a language type (e.g., Python, SQL, and the like), an output format, and a name or identification. In some examples, identification is required for a cell. If a user does not supply an identification, an identification is created for the cell and cannot be removed by the user.

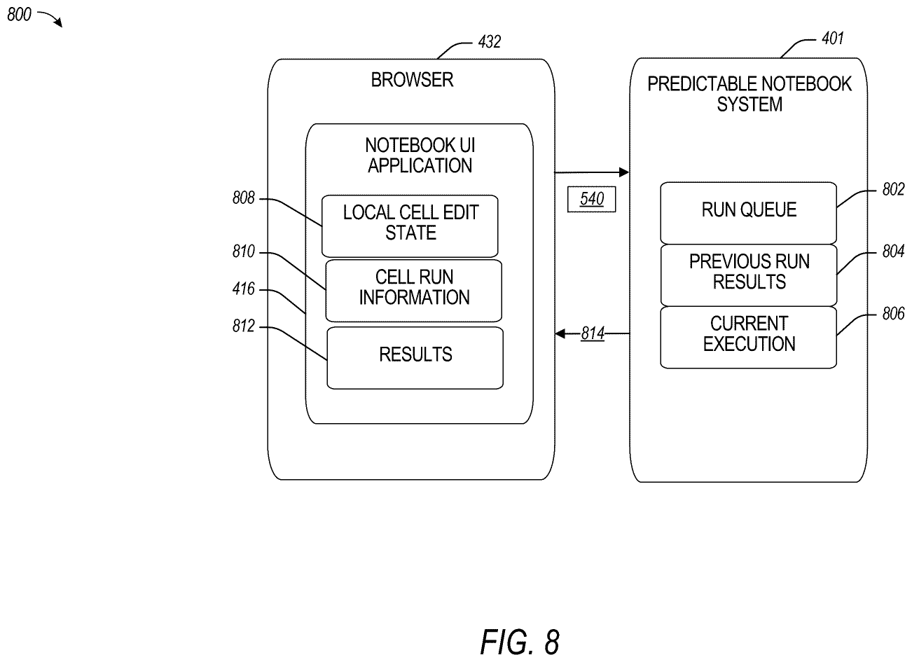

FIG. 8 is a collaboration diagram 800 of a predictable notebook system 401 and a notebook UI application 416 of a browser 432 illustrating how a state is maintained for a notebook, in accordance with some embodiments of the present disclosure. The predictable notebook system 401 and the notebook UI application 416 cooperate to provide a state for the creation and use of a notebook.

A component of the state data for a notebook is stored with the notebook in a document file and termed a “document state” herein. The notebook document includes cells and metadata. The use of the document is to store the code of each cell and metadata on how to run the code without saving any results. The document contains metadata at both the cell and the document level. In some examples, the document is stored in a .ipynb format. The source of the document state data is the notebook UI application 416 (as the notebook UI application 416 is the source of the local cell edit state 808), as a user uses the notebook UI application 416 to edit a notebook and the notebook's respective cells. The notebook UI application 416 is also responsible for displaying to the user results 812 and receiving commands from the user to save cell run information 810.

Another component of the state data for a notebook is an execution state comprising the information about what cells are running and the results of the run. For example, the execution state data includes a state of an execution run queue 802, an in-memory state of what cells have been run and previous run results 804 persisted results from previous runs, and a current execution 806 state of what cells are currently being executing or running.

A relationship between the document state and execution state is maintained through the communication of a set of hashed messages that allows the determination of how a given result maps to a document. For example, a content hash describes the document itself. A content hash comprises hashes of the current cells of the notebook and previous cells. An execution hash describes a particular run of one or more cells and allows the determination of whether an executed run ran against a given document or another result. The predictable notebook system 401 is responsible for generating the hashes and returning them as part of its operations to the browser.

Execution of a run of a set of cells is initiated by a run cells message 540 (described in reference to FIG. 5) that is communicated from the notebook UI application 416 to the predictable notebook system 401. A cell run information message 814 is transmitted from the predictable notebook system 401 to the notebook UI application 416.

The cell run information message 814 comprises one or more hashes and identifications that can be used by the UI engine (or other tools) to make different determinations about results. A predictable notebook system 401 uses a cell run information message 814 when fetching saved results from a datastore or rendering current results in the notebook UI application 416 (of FIG. 4) to determine the results' level of staleness. Table 2 below summarizes an example set of hashes and their uses.

TABLE 2

| Hash | Contents | Use |
|---|---|---|
| self_{—} | Hash of the | Determines whether the results |
| content_{—} | current cell's contents. | match the current cell. However, |
| hash | | it does not take into account |
| | | previous cells. |
| full_{—} | Hash of the | Determines whether the results |
| content_{—} | current contents + | match the current notebook. |
| hash | full_content_hash of the | This looks at previous nodes, |
| | previous cell. | so it will not match if the |
| | | current cell is unchanged but |
| | | the parent is. |
| run_id | A unique | Uniquely identifies this run. |
| | identification created | |
| | for this run. | |
| parent_{—} | Combines the previous | Determines whether this run |
| execution_{—} | cell's full_content_hash | matches the previous cell's |
| id | and run_id to uniquely | results. Catches cases where a |
| | identify content and run. | previous cell was run after |
| | | this cell and has possibly |
| | | inconsistent results. |
| execution_{—} | Combines the run_id, | Determines exact |
| id | self_content_hash and | results and can be |
| | the parent_execution_id | used by later cells to see if |
| | to get an id that uniquely | they were built on this result. |
| | identifies the content | |
| | for this run. | |

In some examples, a UI engine of the predictable notebook system matches a hash of a notebook document state to the hashes in the result stream. In some examples, the UI engine stores content hashes that come back from the results as part of the cell metadata in the document (e.g., a self-content hash and a full content hash). In some examples, the UI engine implements functions to generate a self-content hash and a full content hash locally.

In some aspects, NSM 128 can configure a notebook that supports both SQL and Python cells. For example, NSM 128 can configure a notebook with the following functionalities:
(a) Simple to run a single query and re-use the results. Users can use an SQL cell and use the results in either a visualization, another SQL query, or through Python APIs.
(b) Enable construction of large, complicated SQL queries. For example, NSM can configure the notebook to process complicated SQL statements by breaking them apart into pieces that can be processed individually (e.g., in separate cells) and then combine the results.
(c) Configure a single cell for SQL pre-conditions. Notebooks may require that stages, tables, or views be created in order for the notebook to run. In some aspects, NSM 128 can configure this functionality in a single SQL cell rather than needing to proliferate cells.
(d) Run SQL to obtain results back for machine learning (ML) use cases. This may include getting the results from a query or other results quickly to disk or memory for 3rd party libraries to be able to use.
(e) Handling large results effectively, as some queries may have large results.
(f) Enabling distributed ML operations such as distributed ML model training. The disclosed techniques can be used to configure nodes to pass data between each other and share result data.

In some aspects, NSM 128 can configure notebooks and cells with the following features:
(a) Use results from a cell in later queries.
(b) Use Python variables in SQL to customize queries.
(c) Allow multiple SQL statements per cell that allow them to build off each other.
(d) Provide easy access to results based on at least one Arrow, PANDAS, or Row format.
(e) Send a subset of rows to the browser without having to access all the results first and allow other notebook interactions to use all rows.
(f) Expose result batches to facilitate the passing of references of the results without copying data.

In some aspects, NSM 128 can configure an SQL Cell to use templating engine 466 (e.g., use a basic Jinja template) to generate the SQL that is issued. This functionality allows users to perform variable substitution to create more interactive notebooks or to reuse the results of another cell or step. In some aspects, the output of an SQL cell can be assigned both a variable name that is used in the global namespace 462 and a type (e.g., a data frame type such as the PANDAS data frame).

In some aspects, NSM 128 can perform the following functionalities associated with Jinja and variable substitution. In order to have SQL and Python cells interact together, NSM 128 can configure reusing Python in SQL and vice versa.

The templating engine 466 can be Jinja-based, and Jinja can be used as a templating language for the SQL cells. In some aspects, the templating engine 466 can use other templating languages. In some aspects, NSM 128 can perform templating functions when generating an SQL cell based on the following configurations: variable substitution, “for” loops, and “if” statements.

In some aspects, NSM 128 can perform variable substitution in Jinja by using {{variable}}, which will substitute a variable into the SQL statement. In some aspects, the variable (or the entire SQL statement) can be initially turned into a string.

In some aspects, control flow and other expressions that do not directly return a value can be done with {% %}. This functionality can be performed using Jinja. For example, to iterate through a list, the following statement in Table 3 can be used:

TABLE 3

{% for item in data %}
[BODY]
{% endfor %}

In some aspects, the following “if” statement in Table 4 can be used as well:

TABLE 4

{% if item in data %}
[BODY]
{% endif %}

In some aspects, NSM 128 is configured to support multi-statement SQL cells (e.g., by running all of them when running a cell). The results of the final query will be the only ones written out and will be the ones stored in the cells result collection (e.g., in the results namespace 464).

In some aspects, within a multi-SQL statement, the NSM 128 can configure the prev_query( ) function to allow access to other query results in the cell. However, these results can be accessible while the cell is running. An example of the use of the prev_query( ) function is illustrated in Table 5 below.

TABLE 5
-- query for the left side of the join
select * from my_table;
-- query for the right side of the join
select * from my_other_table;
-- use prev_query to access previous results in cell
Select * from INNER JOIN {{prev_query( )}} ON {{prev_query(2)}};

In the above example, the comments can be ignored, and each query result can be saved for the life of the cell. For queries that are pieced together from a number of parts in the cell, the prev_query( ) function will allow them to get the result. In some aspects, NSM 128 can configure a prev_query API definition (e.g., as described below).

In some aspects, NSM 128 can configure a cache unchanged option on a cell. SQL queries can be expensive to run, and if someone is actively working on configuring a set of queries, it may be expensive to re-run all the queries in the cell, particularly if they are modifying one. The cache_unchanged option can be configured on a cell to allow only running the queries that have not changed since they were last run.

FIG. 9 is a block diagram 900 illustrating a configuration of a cell with a multi-SQL statement, in accordance with some embodiments of the present disclosure. Referring to FIG. 9, NSM 128 can perform Jinja replacement 902 before splitting the SQL into Statements. This functionality can be beneficial for two reasons:
(a) It allows the use of the template language to generate multiple variations of the same query; and
(b) It ensures that the correct SQL is used at the point when the cell is split into multiple statements.

After Jinja replacement 902, NSM 128 can perform splitting 904 of the multi-SQL statement into separate SQL statements, and then processing 906 of the SQL statement. Processing 906 can include injecting SQL results 908 (e.g., using SQL results from one or more other cells), executing the SQL statement 910, and processing results 912. In some aspects, processing the results includes determining if a processing error exists during the SQL execution. If no error is detected, the SQL cell results are stored in a common notebook result space (e.g., result namespace 464). In some aspects, the result namespace 464 can be merged into the global namespace 462.

In some aspects, performing the Jijna replacement 902 first can make the implementation of prev_query( ) ore challenging because, at the time the replacement happens, the previous query will not have been run yet. This means there is no query ID to substitute. To address this, NSM 128 can configure prev_query( ) to inject a random string in the SQL (e.g., the injection can be at a place where the query_id would be). Then, after the SQL is split, it will replace the random string with the actual query ID right before execution.

In some aspects, NSM 128 can configure a notebook with an API to access previous results, allowing the notebook to reuse query results in other queries, work with results locally, and use results in other tools. NSM 128 can configure the following two components to achieve this functionality:
(a) A cell object can be used in the cell's namespace, which can be a collection of cell results. Whenever the executable instructions of a cell are complete, NSM 128 will update this object with its results. Any cell can reference the result of cells that ran before them in the notebook.
(b) NSM 128 can configure query result as the object type that is returned for SQL cells. This object can be configured with a number of functions to make it easy to reuse the object in other queries or to get access to their results.

An example of the usage of SQL results is to create queries that use those results. For example, the_str_function for query result returns the SQL string needed to get the result_scan for those results.

For example, writing an SQL cell that reuses the results from the cell named CELL2 would be as listed in Table 6 below.

TABLE 6

select col1 from {{cells.CELL2}};
Or
select col1 from {{CELL2}};

This would then translate into the SQL as follows: select col2 from TABLE(result_scan([query_id])).

In some aspects, NSM 128 can obtain the actual SQL that was run by calling the executed_sql( ) function as follows: st.write(cells.CELL2.executed_sql( )).

In some aspects, NSM 128 can configure access to the cell results based on the following configurations.

In some aspects, cells object can be used to access cell results. The primary way to access cell results is through a cells object that is part of the namespace. Cell results are then stored as attributes on this object. Syntactically, they can be accessed through either bracket notation or as a property. For example, the following Python calls are equivalent, as listed in Table 7.

TABLE 7

cell2 = cells.CELL2
also_cell2 = cells[“CELL2”]
-- Both are equivalent ways to get the value
cell2 == also_cell2

In some aspects, NSM 128 can configure the prev( ) helper function to allow code to get the results of the cell above it quickly (this will not be the last cell run, but the result of the cell that is above the current one). If that cell has not been run, the call will throw an exception.

In some aspects, this functionality refers to the previous cell and not the code that was just run. This is to help make the programming paradigm for the notebooks more predictable so that the same results when running a notebook through EXECUTE NOTEBOOK are obtained as when they are run interactively.

In some aspects, NSM 128 can configure the following function: prev(cells_back=1)->Any. The prev function takes an optional parameter cells_back. This parameter will determine how many cells to pull the results from. If not specified, the value is 1, and it will pull from the immediately previous cell. If cells_back is a value greater than 1, it will look back that many cells. If cells_back is 0 or negative, this function will fail with an exception.

In some aspects, the query result object is where the results for a query are stored and how they can be referenced. In some aspects, this object can be used to facilitate the reuse of the results within the notebook and prevent re-fetches where appropriate. As a result, the object focuses on getting access to the query ID, the results, and the SQL and trying to re-use any results that were already fetched as part of showing the results for the query.

In some aspects, NSM 128 can use API to_df( )->DataFrame, which returns a data frame that starts with the results of this query. This is a way to start with the results of a SQL cell and then programmatically work with them to make follow-on queries through the Python API.

In some aspects, NSM 128 can use API get_result_batches( )->list[ResultBatch]|None, which returns the list of result batches that can be used for distributing compute across machines or processes. A ResultBatch is pickable and able to retrieve results quickly from the results stage. This makes it suitable for use in distributed training or other operations.

In some aspects, NSM 128 can use API to_arrow( )->Table|None, which returns the results as a single arrow table. Arrow is an open format that can be used to store results in a network-based database system. This allows callers to re-use the arrow with other libraries that support it or to convert it using existing libraries that make it easy to convert Arrow to formats like CSV, Feather, or Parquet

In some aspects, NSM 128 can use API to_arrow_batches( )->Iterable[Table], which returns an iterator of arrow tables. This can work better for large results than to_arrow( ) because it allows for returning results before they are all downloaded. It also allows for not having them all in memory at one time.

In some aspects, NSM 128 can use API to_pandas( )->pandas.DataFrame, which returns the results as a PANDAS data frame. PANDAS is a standard library for working with data, and PANDAS work well with the underlying Arrow results.

In some aspects, NSM 128 can use API to_pandas_batches( )->Iterator[pandas.DataFrame], which returns an iterator of PANDAS batches. This can be more efficient for dealing with large results or getting a single large result.

In some aspects, NSM 128 can use API to_rows( )->List[Row], which returns the results as a list of rows.

In some aspects, NSM 128 can use API to_iter( )->Iterator[Row], which returns an iterator of results.

In some aspects, NSM 128 can use API sfqid( )->str, which returns the query ID for these results.

In some aspects, NSM 128 can use API result_scan_sql( )->str, which returns the SQL that references the results as a table. For example, this API can be used as follows: TABLE(result_scan([query_id])).

In some aspects, NSM 128 can use API executed_sql( )->str, which returns the SQL that was run after the Jinja substitution. This is useful for debugging and seeing precisely what was run.

In some aspects, NSM 128 can use API_str_( )->str. The string representation of these objects turns into the SQL to access the results_scan. This API can be used to make reuse in SQL templates easier.

In some aspects, NSM 128 can use API_iter_( )->Iterator[Row]. The iter functionality can be configured to allow easy iteration of the rows.

In some aspects, NSM 128 can be configured to access query results within a SQL Cell based on prev_query(count: int=1)->QueryResult. When running multiple queries from a single SQL cell, this function will allow a query to access results from a previous query in the same cell.

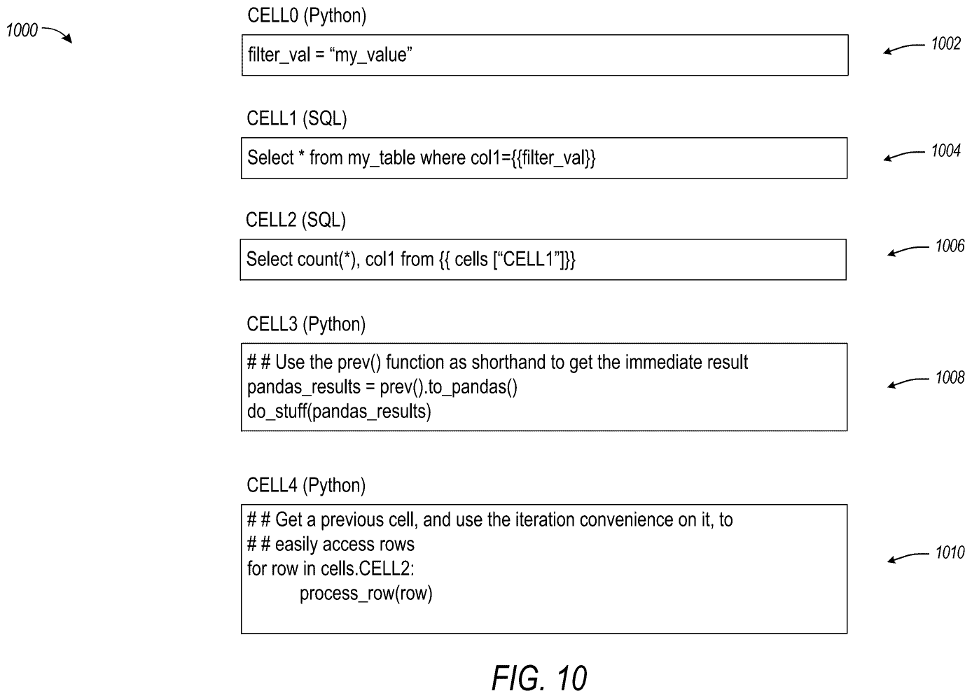

FIG. 10 illustrates a diagram 1000 of chaining queries in multiple cells (e.g., cells 1002, 1004, 1006, 1008, and 1010) of a notebook, in accordance with some embodiments of the present disclosure. The examples in FIG. 10 show several ways to use results across SQL and Python cells.

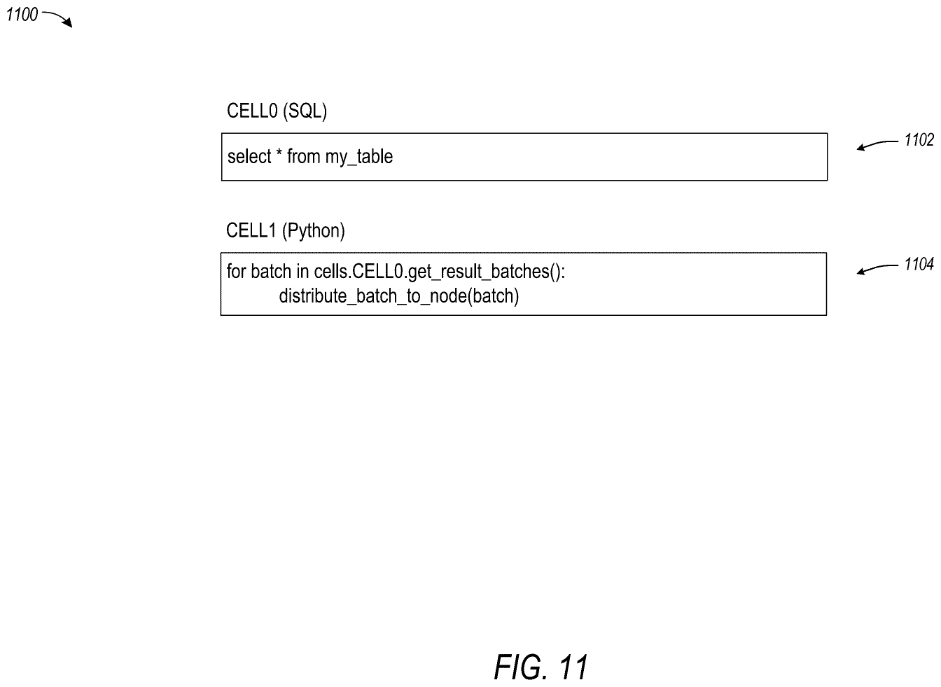

FIG. 11 illustrates diagram 1100 of a configuration of distributed machine learning (ML) operations in multiple cells (e.g., cells 1102 and 1104) of a notebook, in accordance with some embodiments of the present disclosure.

In some aspects, the disclosed techniques can be used for distributed ML operations. For ML operations, it may be essential to chunk out results and pass them to other CPUs or instances for processing. To do this efficiently, callers can take advantage of ResultBatches (e.g., pointers to the results in a result stage). Instead, the references pre-sign URLs that allow each node to pull down the data that it needs. To perform this function, the SQL cells can be used to do the query. However, in later Python cells, the ResultBatches can be used to pass out the work.

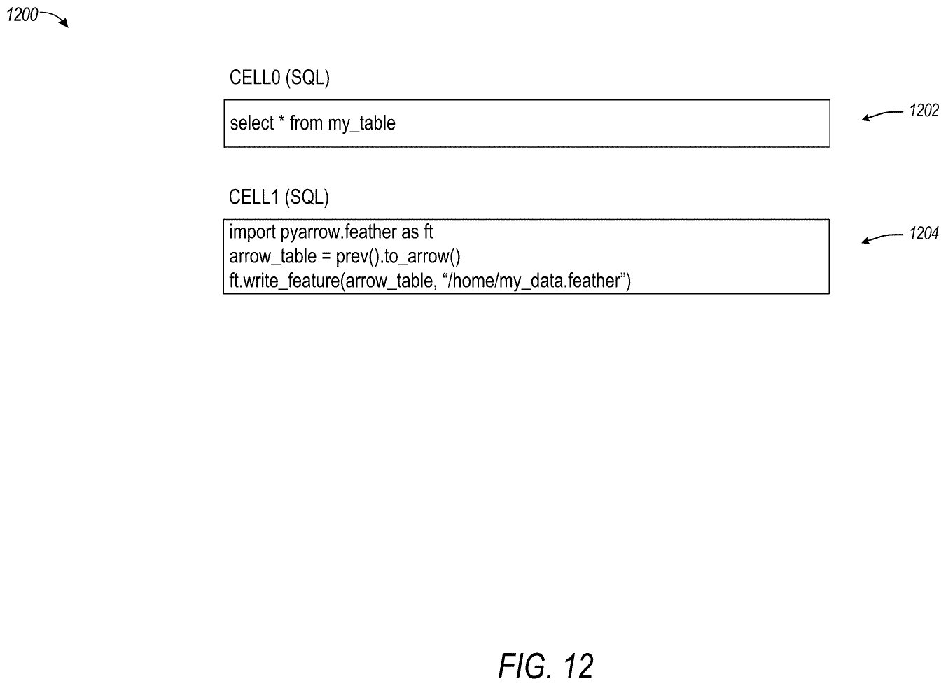

FIG. 12 illustrates diagram 1200 of a configuration of writing Arrow files locally in connection with multiple cells (e.g., cells 1202 and 1204) of a notebook, in accordance with some embodiments of the present disclosure.

In some aspects, the disclosed techniques can be used in connection with writing Arrow files locally. Arrow is a popular format for re-using in-memory results across components and processes. In some aspects, Arrow can be used natively to store results. The disclosed techniques can be used to facilitate storing such results using Arrow (e.g., based on running queries and using the results in memory).

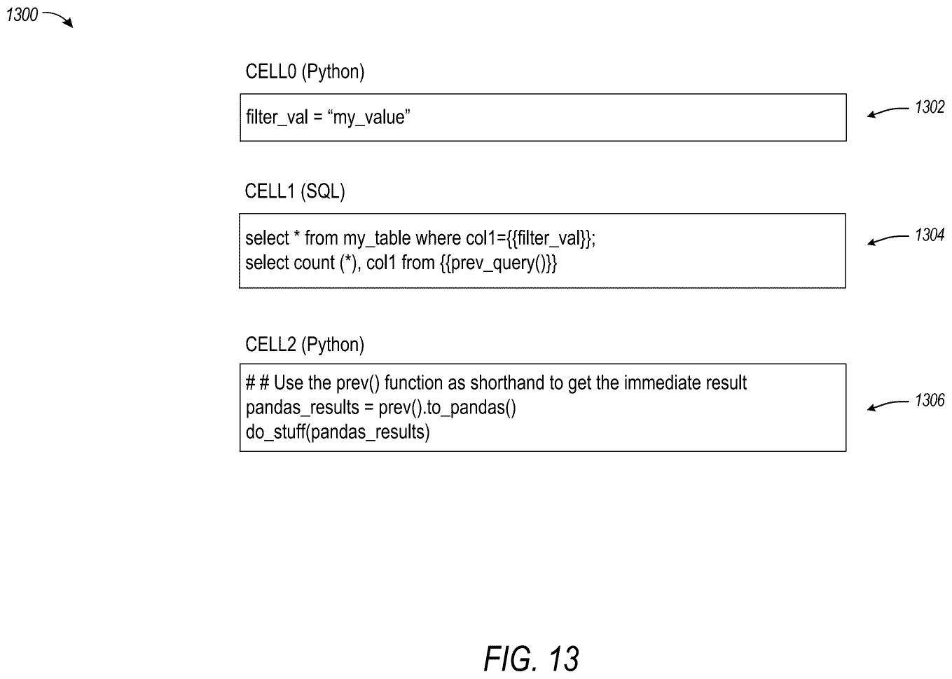

FIG. 13 illustrates diagram 1300 of a configuration of multi-statement SQL cells (e.g., cells 1302, 1304, and 1306) of a notebook, in accordance with some embodiments of the present disclosure.

In some aspects, NSM 128 can configure multi-statement SQL cells based on the disclosed techniques. In the examples in FIG. 13, a single cell for SQL is configured by using a multi-statement. The last result is available outside the cell, but within the cell, prev_query( ) can be used to access previous results.

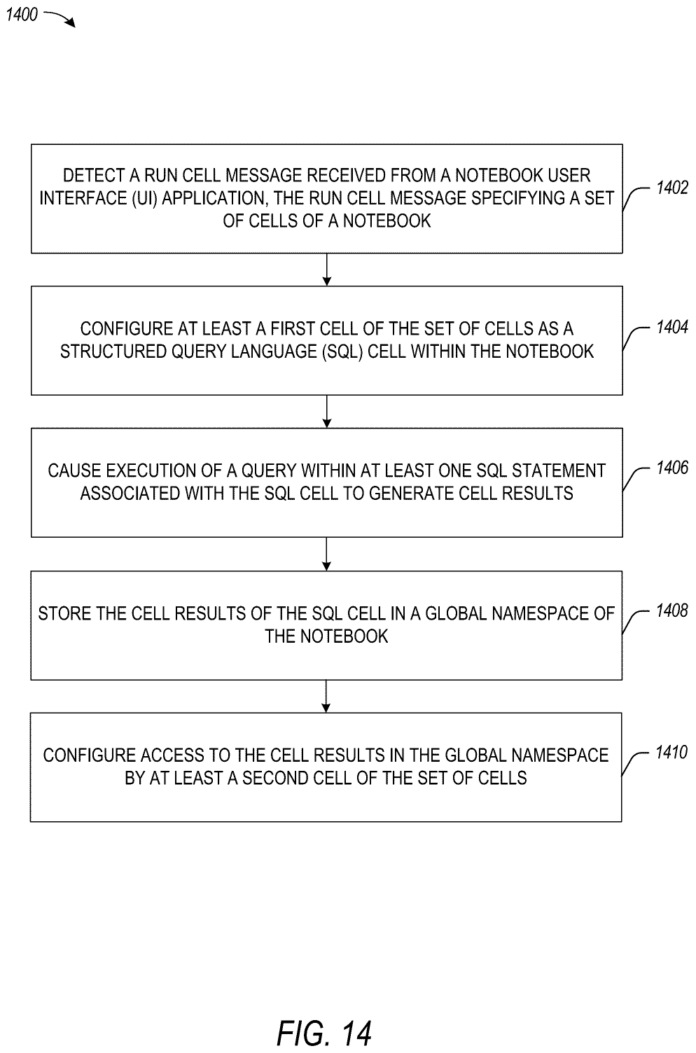

FIG. 14 is a flow diagram illustrating the operations of a database system in performing a method for configuring interaction between different types of cells in a notebook, in accordance with some embodiments of the present disclosure. Method 1400 may be embodied in computer-readable instructions for execution by one or more hardware components (e.g., one or more processors) such that the operations of method 1400 may be performed by components of network-based database system 102, such as components of the execution platform 110 (e.g., the NSM 128) and/or the compute service manager 108 (which components may be implemented as machine 1500 of FIG. 15). Accordingly, method 1400 is described below, by way of example with reference thereto. However, it should be noted that method 1400 may be deployed on various other hardware configurations and is not intended to be limited to deployment within the network-based database system 102.

At operation 1402, a run cell message received from a notebook User Interface (UI) application is detected. The run cell message specifies a set of cells of a notebook.

At operation 1404, at least a first cell of the set of cells is configured as a Structured Query Language (SQL) cell within the notebook.

At operation 1406, a query within at least one SQL statement associated with the SQL cell can be executed to generate cell results (e.g., the SQL statement is performed).

At operation 1408, the cell results of the SQL cell are stored in a global namespace of the notebook.

At operation 1410, access to the cell results in the global namespace being configured to at least a second cell of the set of cells.

FIG. 15 illustrates a diagrammatic representation of machine 1500 in the form of a computer system within which a set of instructions may be executed to cause machine 1500 to perform any one or more of the methodologies discussed herein, according to an example embodiment. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. For example, instructions 1516 may cause machine 1500 to execute any one or more operations of method 1400 (or any other technique discussed herein, for example, in connection with FIG. 4-FIG. 14). As another example, instructions 1516 may cause machine 1500 to implement one or more portions of the functionalities discussed herein. In this way, instructions 1516 may transform a general, non-programmed machine into a particular machine 1500 (e.g., the compute service manager 108 or a node in the execution platform 110) that is specially configured to carry out any one of the described and illustrated functions in the manner described herein. In yet another embodiment, instructions 1516 may configure the compute service manager 108 and/or a node in the execution platform 110 to carry out any one of the described and illustrated functions in the manner described herein.

In alternative embodiments, the machine 1500 operates as a standalone device or may be coupled (e.g., networked) to other machines. In a networked deployment, machine 1500 may operate in the capacity of a server machine or a client machine in a server-client network environment or as a peer machine in a peer-to-peer (or distributed) network environment. The machine 1500 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1516, sequentially or otherwise, that specify actions to be taken by the machine 1500. Further, while only a single machine 1500 is illustrated, the term “machine” shall also be taken to include a collection of machines 1500 that individually or jointly execute the instructions 1516 to perform any one or more of the methodologies discussed herein.

Machine 1500 includes processors 1510, memory 1530, and input/output (I/O) components 1550 configured to communicate with each other, such as via a bus 1502. In some example embodiments, the processors 1510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1512 and a processor 1514 that may execute the instructions 1516. The term “processor” is intended to include multi-core processors 1510 that may comprise two or more independent processors (sometimes referred to as “cores”) that may execute instructions 1516 contemporaneously. Although FIG. 15 shows multiple processors 1510, the machine 1500 may include a single processor with a single core, a single processor with multiple cores (e.g., a multi-core processor), multiple processors with a single core, multiple processors with multiple cores, or any combination thereof.

The memory 1530 may include a main memory 1532, a static memory 1534, and a storage unit 1536, all accessible to the processors 1510, such as via the bus 1502. The main memory 1532, the static memory 1534, and the storage unit 1536 store the instructions 1516, which embody any one or more of the methodologies or functions described herein. The instructions 1516 may also reside, wholly or partially, within the main memory 1532, within the static memory 1534, within machine storage medium 1538 of the storage unit 1536, within at least one of the processors 1510 (e.g., within the processor's cache memory), or any suitable combination thereof, during execution thereof by the machine 1500.

The I/O components 1550 include components to receive input, provide output, produce output, transmit information, exchange information, capture measurements, and so on. The specific I/O components 1550 that are included in a particular machine 1500 will depend on the type of machine. For example, portable machines such as mobile phones will likely include a touch input device or other such input mechanisms, while a headless server machine will likely not include such a touch input device. It would be appreciated that the I/O components 1550 may include many other components that are not shown in FIG. 15. The I/O components 1550 are grouped according to functionality merely to simplify the following discussion, and the grouping is in no way limiting. In various example embodiments, the I/O components 1550 may include output components 1552 and input components 1554. The output components 1552 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1550 may include communication components 1564, operable to couple the machine 1500 to a network 1580 or devices 1570 via a coupling 1582 and a coupling 1572, respectively. For example, the communication components 1564 may include a network interface component or another suitable device to interface with the network 1580. In further examples, communication components 1564 may include wired communication components, wireless communication components, cellular communication components, and other communication components to provide communication via other modalities. The device 1570 may be another machine or any of a wide variety of peripheral devices (e.g., a peripheral device coupled via a universal serial bus (USB)). For example, as noted above, machine 1500 may correspond to any one of the compute service manager 108 or the execution platform 110, and device 1570 may include the client device 114 or any other computing device described herein as being in communication with the network-based database system 102 or the cloud storage platform 104.

The various memories (e.g., 1530, 1532, 1534, and/or memory of the processor(s) 1510 and/or the storage unit 1536) may store one or more sets of instructions 1516 and data structures (e.g., software) embodying or utilized by any one or more of the methodologies or functions described herein. These instructions 1516, when executed by the processor(s) 1510, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database and/or associated caches and servers) that store executable instructions and/or data. The terms shall accordingly be taken to include, but not be limited to, solid-state memories and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1580 or a portion of network 1580 may include a wireless or cellular network, and the coupling 1582 may be a Code Division Multiple Access (CDMA) connection, a Global System for Mobile Communications (GSM) connection, or another cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standards, others defined by various standard-setting organizations, other long-range protocols, or other data transfer technology.

The instructions 1516 may be transmitted or received over network 1580 using a transmission medium via a network interface device (e.g., a network interface component included in the communication components 1564) and utilizing any one of several well-known transfer protocols (e.g., hypertext transfer protocol (HTTP)). Similarly, instructions 1516 may be transmitted or received using a transmission medium via coupling 1572 (e.g., a peer-to-peer coupling) to device 1570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1516 for execution by the machine 1500 and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments, the processors may be distributed across several locations.

Described implementations of the subject matter can include one or more features, alone or in combination, as illustrated below by way of examples.

Example 1 is a system comprising at least one hardware processor and at least one memory storing instructions that cause the at least one hardware processor to perform operations comprising: detecting a run cell message received from a notebook User Interface (UI) application, the run cell message specifying a set of cells of a notebook; configuring at least a first cell of the set of cells as a Structured Query Language (SQL) cell within the notebook; causing execution of a query within at least one SQL statement associated with the SQL cell to generate cell results; storing the cell results of the SQL cell in a global namespace of the notebook; and configuring access to the cell results in the global namespace by at least a second cell of the set of cells.

In Example 2, the subject matter of Example 1 includes functionalities such as configuring the notebook via a notebook adapter of a user-defined function (UDF) executing at a computing node of a database system.

In Example 3, the subject matter of Examples 1-2 includes functionalities such as assigning the cell results stored in the global namespace, a variable name, and a type.

In Example 4, the subject matter of Example 3 includes functionalities such as configuring the at least second cell of the set of cells as a Python cell and causing retrieval of the cell results of the SQL cell by the Python cell from the global namespace based at least on the variable name.

In Example 5, the subject matter of Examples 1-4 includes functionalities such as generating the at least first cell as the SQL cell based on a templating engine associated with the notebook.

In Example 6, the subject matter of Example 5 includes subject matter where the templating engine is a Jinja templating engine, and the operations comprising: causing variable substitution of one or more variables in the at least one SQL statement with one or more strings based on the Jinja templating engine to generate a revised SQL statement; and process the revised SQL statement to obtain the cell results.

In Example 7, the subject matter of Examples 1-6 includes functionalities such as detecting the at least one SQL statement within the SQL cell comprises a multi-SQL statement and performing a templating engine substitution of one or more variables in the multi-SQL statement to generate a revised multi-SQL statement.

In Example 8, the subject matter of Example 7 includes functionalities such as splitting the revised multi-SQL statement into a plurality of SQL statements and causing execution of the plurality of SQL statements to generate the cell results.

In Example 9, the subject matter of Example 8 includes functionalities such as splitting the SQL cell into a plurality of SQL cells, each of the plurality of SQL cells associated with a corresponding one of the plurality of SQL statements.

In Example 10, the subject matter of Examples 1-9 includes functionalities such as storing the cell results of the SQL cell in a cell object within the global namespace of the notebook, the cell object comprising the cell results of the SQL cell, and at least one additional cell result of the at least second cell.

Example 11 is a method comprising: detecting, by at least one hardware processor, a run cell message received from a notebook User Interface (UI) application, the run cell message specifying a set of cells of a notebook; configuring at least a first cell of the set of cells as a Structured Query Language (SQL) cell within the notebook; causing execution of a query within at least one SQL statement associated with the SQL cell to generate cell results; storing the cell results of the SQL cell in a global namespace of the notebook; and configuring access to the cell results in the global namespace by at least a second cell of the set of cells.

In Example 12, the subject matter of Example 11 includes configuring the notebook via a notebook adapter of a user-defined function (UDF) executing at a computing node of a database system.

In Example 13, the subject matter of Examples 11-12 includes assigning the cell results stored in the global namespace, a variable name, and a type.

In Example 14, the subject matter of Example 13 includes configuring the at least second cell of the set of cells as a Python cell and causing retrieval of the cell results of the SQL cell by the Python cell from the global namespace based at least on the variable name.

In Example 15, the subject matter of Examples 11-14 includes generating the at least first cell as the SQL cell based on a templating engine associated with the notebook.

In Example 16, the subject matter of Example 15 includes subject matter where the templating engine is a Jinja templating engine, and the method comprising: causing variable substitution of one or more variables in the at least one SQL statement with one or more strings based on the Jinja templating engine to generate a revised SQL statement; and process the revised SQL statement to obtain the cell results.

In Example 17, the subject matter of Examples 11-16 includes detecting the at least one SQL statement within the SQL cell comprises a multi-SQL statement and performing a templating engine substitution of one or more variables in the multi-SQL statement to generate a revised multi-SQL statement.

In Example 18, the subject matter of Example 17 includes splitting the revised multi-SQL statement into a plurality of SQL statements and causing execution of the plurality of SQL statements to generate the cell results.

In Example 19, the subject matter of Example 18 includes splitting the SQL cell into a plurality of SQL cells, each of the plurality of SQL cells associated with a corresponding one of the plurality of SQL statements.

In Example 20, the subject matter of Examples 11-19 includes storing the cell results of the SQL cell in a cell object within the global namespace of the notebook, the cell object comprising the cell results of the SQL cell, and at least one additional cell result of the at least second cell.

Example 21 is a computer-storage medium comprising instructions that, when executed by one or more processors of a machine, configure the machine to perform operations comprising detecting a run cell message received from a notebook User Interface (UI) application, the run cell message specifying a set of cells of a notebook; configuring at least a first cell of the set of cells as a Structured Query Language (SQL) cell within the notebook; causing execution of a query within at least one SQL statement associated with the SQL cell to generate cell results; storing the cell results of the SQL cell in a global namespace of the notebook; and configuring access to the cell results in the global namespace by at least a second cell of the set of cells.

In Example 22, the subject matter of Example 21 includes functionalities such as configuring the notebook via a notebook adapter of a user-defined function (UDF) executing at a computing node of a database system.

In Example 23, the subject matter of Examples 21-22 includes functionalities such as assigning the cell results stored in the global namespace, a variable name, and a type.

In Example 24, the subject matter of Example 23 includes functionalities such as configuring the at least second cell of the set of cells as a Python cell and causing retrieval of the cell results of the SQL cell by the Python cell from the global namespace based at least on the variable name.

In Example 25, the subject matter of Examples 21-24 includes functionalities such as generating the at least first cell as the SQL cell based on a templating engine associated with the notebook.

In Example 26, the subject matter of Example 25 includes subject matter where the templating engine is a Jinja templating engine, and the operations comprising: causing variable substitution of one or more variables in the at least one SQL statement with one or more strings based on the Jinja templating engine to generate a revised SQL statement; and process the revised SQL statement to obtain the cell results.

In Example 27, the subject matter of Examples 21-26 includes functionalities such as detecting the at least one SQL statement within the SQL cell comprises a multi-SQL statement and performing a templating engine substitution of one or more variables in the multi-SQL statement to generate a revised multi-SQL statement.

In Example 28, the subject matter of Example 27 includes functionalities such as splitting the revised multi-SQL statement into a plurality of SQL statements and causing execution of the plurality of SQL statements to generate the cell results.

In Example 29, the subject matter of Example 28 includes functionalities such as splitting the SQL cell into a plurality of SQL cells, each of the plurality of SQL cells associated with a corresponding one of the plurality of SQL statements.

In Example 30, the subject matter of Examples 21-29 includes functionalities such as storing the cell results of the SQL cell in a cell object within the global namespace of the notebook, the cell object comprising the cell results of the SQL cell, and at least one additional cell result of the at least second cell.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments and other embodiments not explicitly described herein will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
at least one memory storing instructions that cause the at least one hardware processor to perform operations comprising:
detecting a run cell message received from a notebook User Interface (UI) application, the run cell message specifying a set of cells of a notebook and metadata indicating a cell type;
configuring at least a first cell of the set of cells as a Structured Query Language (SQL) cell within the notebook based on the cell type;
causing execution of a query within at least one SQL statement associated with the SQL cell to generate cell results;
storing the cell results of the SQL cell in a global namespace of the notebook; and
configuring access to the cell results in the global namespace by at least a second cell of the set of cells.

2. The system of claim 1, the operations comprising:
configuring the notebook via a notebook adapter of a user-defined function (UDF) executing at a computing node of a database system.

3. The system of claim 1, the operations comprising:
assigning the cell results stored in the global namespace, a variable name and a type.

4. The system of claim 3, the operations comprising:
configuring the at least second cell of the set of cells as a Python cell; and
causing retrieval of the cell results of the SQL cell by the Python cell from the global namespace based at least on the variable name.

5. The system of claim 1, the operations comprising:
generating the at least first cell as the SQL cell based on a templating engine associated with the notebook.

6. The system of claim 5, wherein the templating engine is a Jinja templating engine, and the operations comprising:
causing variable substitution of one or more variables in the at least one SQL statement with one or more strings based on the Jinja templating engine to generate a revised SQL statement; and
process the revised SQL statement to obtain the cell results.

7. The system of claim 1, the operations comprising:
detecting the at least one SQL statement within the SQL cell comprises a multi-SQL statement; and
performing a templating engine substitution of one or more variables in the multi-SQL statement to generate a revised multi-SQL statement.

8. The system of claim 7, the operations comprising:
splitting the revised multi-SQL statement into a plurality of SQL statements; and
causing execution of the plurality of SQL statements to generate the cell results.

9. The system of claim 8, the operations comprising:
splitting the SQL cell into a plurality of SQL cells, each of the plurality of SQL cells associated with a corresponding one of the plurality of SQL statements.

10. The system of claim 1, the operations comprising:
storing the cell results of the SQL cell in a cell object within the global namespace of the notebook, the cell object comprising the cell results of the SQL cell and at least one additional cell result of the at least second cell.

11. A method comprising:
detecting, by at least one hardware processor, a run cell message received from a notebook User Interface (UI) application, the run cell message specifying a set of cells of a notebook and metadata indicating a cell type;
configuring at least a first cell of the set of cells as a Structured Query Language (SQL) cell within the notebook based on the cell type;
causing execution of a query within at least one SQL statement associated with the SQL cell to generate cell results;
storing the cell results of the SQL cell in a global namespace of the notebook; and
configuring access to the cell results in the global namespace by at least a second cell of the set of cells.

12. The method of claim 11, further comprising:
configuring the notebook via a notebook adapter of a user-defined function (UDF) executing at a computing node of a database system.

13. The method of claim 11, further comprising:
assigning the cell results stored in the global namespace, a variable name and a type.

14. The method of claim 13, further comprising:
configuring the at least second cell of the set of cells as a Python cell; and
causing retrieval of the cell results of the SQL cell by the Python cell from the global namespace based at least on the variable name.

15. The method of claim 11, further comprising:
generating the at least first cell as the SQL cell based on a templating engine associated with the notebook.

16. The method of claim 15, wherein the templating engine is a Jinja templating engine, and the method comprising:
causing variable substitution of one or more variables in the at least one SQL statement with one or more strings based on the Jinja templating engine to generate a revised SQL statement; and
process the revised SQL statement to obtain the cell results.

17. The method of claim 11, further comprising:
detecting the at least one SQL statement within the SQL cell comprises a multi-SQL statement; and
performing a templating engine substitution of one or more variables in the multi-SQL statement to generate a revised multi-SQL statement.

18. The method of claim 17, further comprising:
splitting the revised multi-SQL statement into a plurality of SQL statements; and
causing execution of the plurality of SQL statements to generate the cell results.

19. The method of claim 18, further comprising:
splitting the SQL cell into a plurality of SQL cells, each of the plurality of SQL cells associated with a corresponding one of the plurality of SQL statements.

20. The method of claim 11, further comprising:
storing the cell results of the SQL cell in a cell object within the global namespace of the notebook, the cell object comprising the cell results of the SQL cell and at least one additional cell result of the at least second cell.

21. A computer-storage medium comprising instructions that, when executed by one or more processors of a machine, configure the machine to perform operations comprising:
detecting a run cell message received from a notebook User Interface (UI) application, the run cell message specifying a set of cells of a notebook and metadata indicating a cell type;
configuring at least a first cell of the set of cells as a Structured Query Language (SQL) cell within the notebook based on the cell type;
causing execution of a query within at least one SQL statement associated with the SQL cell to generate cell results;
storing the cell results of the SQL cell in a global namespace of the notebook; and
configuring access to the cell results in the global namespace by at least a second cell of the set of cells.

22. The computer-storage medium of claim 21, the operations comprising:
configuring the notebook via a notebook adapter of a user-defined function (UDF) executing at a computing node of a database system.

23. The computer-storage medium of claim 21, the operations comprising:
assigning the cell results stored in the global namespace, a variable name and a type.

24. The computer-storage medium of claim 23, the operations comprising:
configuring the at least second cell of the set of cells as a Python cell; and
causing retrieval of the cell results of the SQL cell by the Python cell from the global namespace based at least on the variable name.

25. The computer-storage medium of claim 21, the operations comprising:
generating the at least first cell as the SQL cell based on a templating engine associated with the notebook.

26. The computer-storage medium of claim 25, wherein the templating engine is a Jinja templating engine, and the operations comprising:
causing variable substitution of one or more variables in the at least one SQL statement with one or more strings based on the Jinja templating engine to generate a revised SQL statement; and
process the revised SQL statement to obtain the cell results.

27. The computer-storage medium of claim 21, the operations comprising:
Page 7 detecting the at least one SQL statement within the SQL cell comprises a multi-SQL statement; and
performing a templating engine substitution of one or more variables in the multi-SQL statement to generate a revised multi-SQL statement.

28. The computer-storage medium of claim 27, the operations comprising:
splitting the revised multi-SQL statement into a plurality of SQL statements; and
causing execution of the plurality of SQL statements to generate the cell results.

29. The computer-storage medium of claim 28, the operations comprising:
splitting the SQL cell into a plurality of SQL cells, each of the plurality of SQL cells associated with a corresponding one of the plurality of SQL statements.

30. The computer-storage medium of claim 21, the operations comprising:
storing the cell results of the SQL cell in a cell object within the global namespace of the notebook, the cell object comprising the cell results of the SQL cell and at least one additional cell result of the at least second cell.
